(19) United States
(12) Patent Application Publication
(10) Pub. No.: US 2024/0204218 A1
(43) Pub. Date: Jun. 20, 2024

(54) FUEL CELL SYSTEM CONFIGURED TO OPERATE IN COLD CONDITIONS AND METHOD OF OPERATING THE SAME

(71) Applicant: BLOOM ENERGY CORPORATION, San Jose, CA (US)

(72) Inventors: David WEINGAERTNER, Sunnyvale, CA (US); Karen J. LEE, San Jose, CA (US); David EDMONSTON, Soquel, CA (US); Jessica MAHLER, Palo Alto, CA (US)

(21) Appl. No.: 18/529,414

(22) Filed: Dec. 5, 2023

Related U.S. Application Data
(60) Provisional application No. 63/476,016, filed on Dec. 19, 2022.

(51) Int. Cl. H01M 8/04014; H01M 8/04007; H01M 8/04089; H01M 8/04223; H01M 8/04225; H01M 8/2425

(52) U.S. Cl. CPC H01M 8/04014; H01M 8/04074; H01M 8/04089; H01M 8/04225; H01M 8/04253; H01M 8/04268; H01M 8/2425

(57) ABSTRACT

A method of operating a fuel cell system includes providing an anode exhaust stream from a stack of fuel cells into an anode exhaust cooler, providing an air inlet stream into the anode exhaust cooler and heating the air inlet stream using heat extracted from the anode exhaust stream, providing a heated air inlet stream output from the anode exhaust cooler into the stack, providing a cooled anode exhaust stream at a temperature between 110° C. and 180° C. from the anode exhaust cooler into an anode recycle blower, and recycling at least a portion of the cooled anode exhaust stream into a fuel inlet stream provided into the stack.

### FIELD

Aspects of the present invention relate to fuel cell systems, and more particularly, to fuel cell systems configured to operate in cold conditions.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels or hydrogen containing fuels such as ammonia. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a fuel cell system includes a stack of fuel cells, an anode exhaust cooler configured to heat an air inlet stream using heat extracted from an anode exhaust stream output from the stack, a first air conduit fluidly connected to an air inlet of the anode exhaust cooler and configured to provide an air inlet stream to the anode exhaust cooler, a second air conduit connected to an air outlet of the anode exhaust cooler and configured to receive a heated air inlet stream output from the anode exhaust cooler and to provide the heated air inlet stream into the stack, a first anode exhaust conduit fluidly connecting an anode exhaust outlet of the stack to an anode exhaust inlet of the anode exhaust cooler, a second anode exhaust conduit fluidly connecting an anode exhaust outlet of the anode exhaust cooler to a fuel inlet of the stack, and at least one component configured to maintain a temperature of an anode exhaust stream exiting the anode exhaust cooler into the second anode exhaust conduit at a temperature above 100° C.

According to various embodiments, a method of operating a fuel cell system includes providing an anode exhaust stream from a stack of fuel cells into an anode exhaust cooler, providing an air inlet stream into the anode exhaust cooler and heating the air inlet stream using heat extracted from the anode exhaust stream, providing a heated air inlet stream output from the anode exhaust cooler into the stack, providing a cooled anode exhaust stream at a temperature between 110° C. and 180° C. from the anode exhaust cooler into an anode recycle blower, and recycling at least a portion of the cooled anode exhaust stream into a fuel inlet stream provided into the stack.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a schematic of a fuel cell system, according to various embodiments of the present disclosure.

FIG. 2A is a sectional view showing components of the hot box of the system of FIG. 1, FIG. 2B shows an enlarged portion of the system of FIG. 2A, FIG. 2C is a three dimensional cut-away view of a central column of the system of FIG. 2A, and FIG. 2D is a perspective view of an anode hub structure disposed below the central column of the system of FIG. 2A, according to various embodiments of the present disclosure.

FIGS. 3A-3C are sectional views showing fuel and air flow through the central column of the system of FIG. 2A, according to various embodiments of the present disclosure.

FIG. 4A is a partial perspective view showing fuel and air flow through an anode exhaust cooler of FIG. 1. FIG. 4B is a partial cross-sectional view of the anode exhaust cooler and hotbox of FIG. 1, according to one embodiment of the present disclosure.

FIGS. 5A and 5B are partial cross-sectional views of the anode exhaust cooler and hotbox of FIG. 1, according to alternative embodiments of the present disclosure.

FIG. 6 is a schematic of a fuel cell system, according to an alternative embodiment of the present disclosure.

FIG. 7A is a schematic of a fuel cell system, according to another alternative embodiment of the present disclosure, and FIG. 7B is a partial cross-sectional view of the anode exhaust cooler and hotbox of FIG. 7A, according to another alternative embodiment of the present disclosure.

FIG. 8 is a schematic of a fuel cell system, according to another alternative embodiment of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

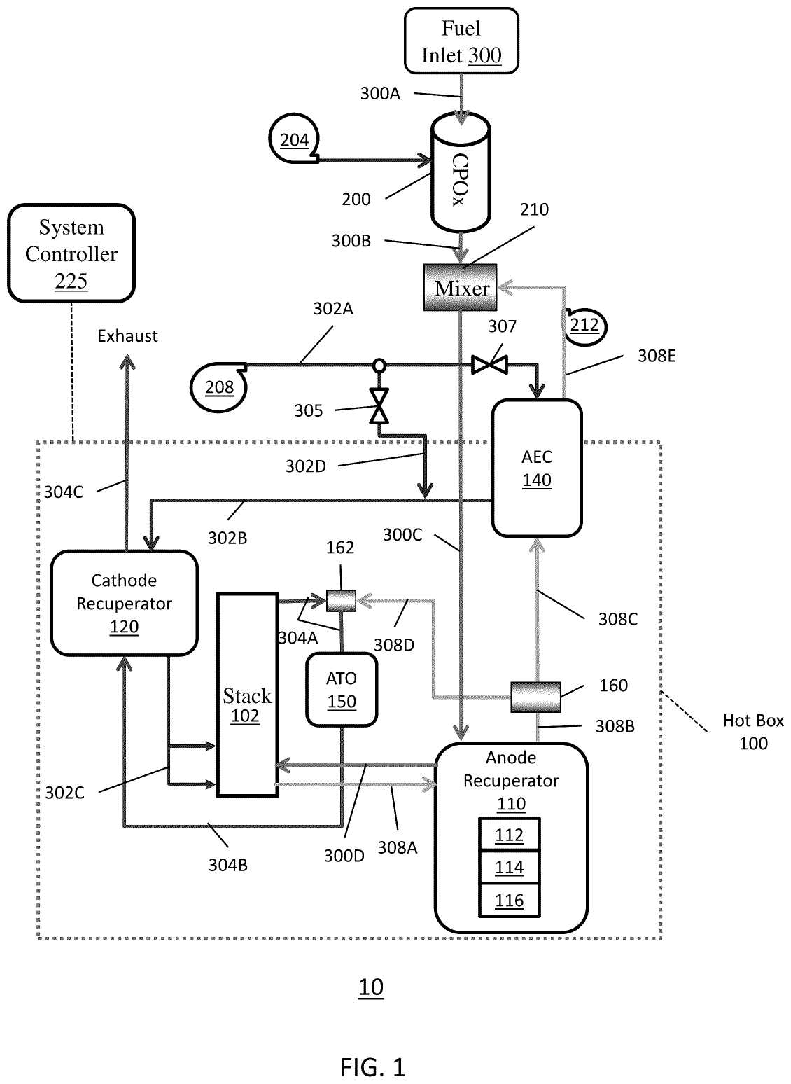

FIG. 1 is a schematic representation of a SOFC system 10, according to various embodiments of the present disclosure. Referring to FIG. 1, the system 10 includes a hotbox 100 and various components disposed therein or adjacent thereto. The hot box 100 may contain fuel cell stacks 102, such as a solid oxide fuel cell stacks containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other to create a single column with a plurality of columns contained in a single hot box, or each stack may comprise one large column with multiple columns contained in a single hot box.

The hot box 100 may also contain an anode recuperator heat exchanger 110, a cathode recuperator heat exchanger 120, an anode tail gas oxidizer (ATO) 150, an anode exhaust cooler heat exchanger 140, a splitter 160, and a vortex generator 162. The system 10 may also include a catalytic partial oxidation (CPOx) reactor 200, a mixer 210, a CPOx blower 204 (e.g., air blower), a system blower 208 (e.g., air blower), and an anode recycle blower 212, which may be disposed outside of the hotbox 100. However, the present disclosure is not limited to any particular location for each of the components with respect to the hotbox 100.

The CPOx reactor 200 receives a fuel inlet stream from a fuel inlet 300, through fuel conduit 300A. The fuel inlet 300 may be a fuel tank or a utility natural gas line including a valve to control an amount of fuel provided to the CPOx reactor 200. The CPOx blower 204 may provide air to the CPOx reactor 202 during system start-up. The fuel and/or air may be provided to the mixer 210 by fuel conduit 300B. Fuel flows from the mixer 210 to the anode recuperator 110 through fuel conduit 300C. The fuel is heated in the anode recuperator 110 by a portion of the fuel exhaust supplied by conduit 308A and the fuel then flows from the anode recuperator 110 to the stacks 102 through fuel conduit 300D.

The system blower 208 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stacks 102 through air conduit 302C.

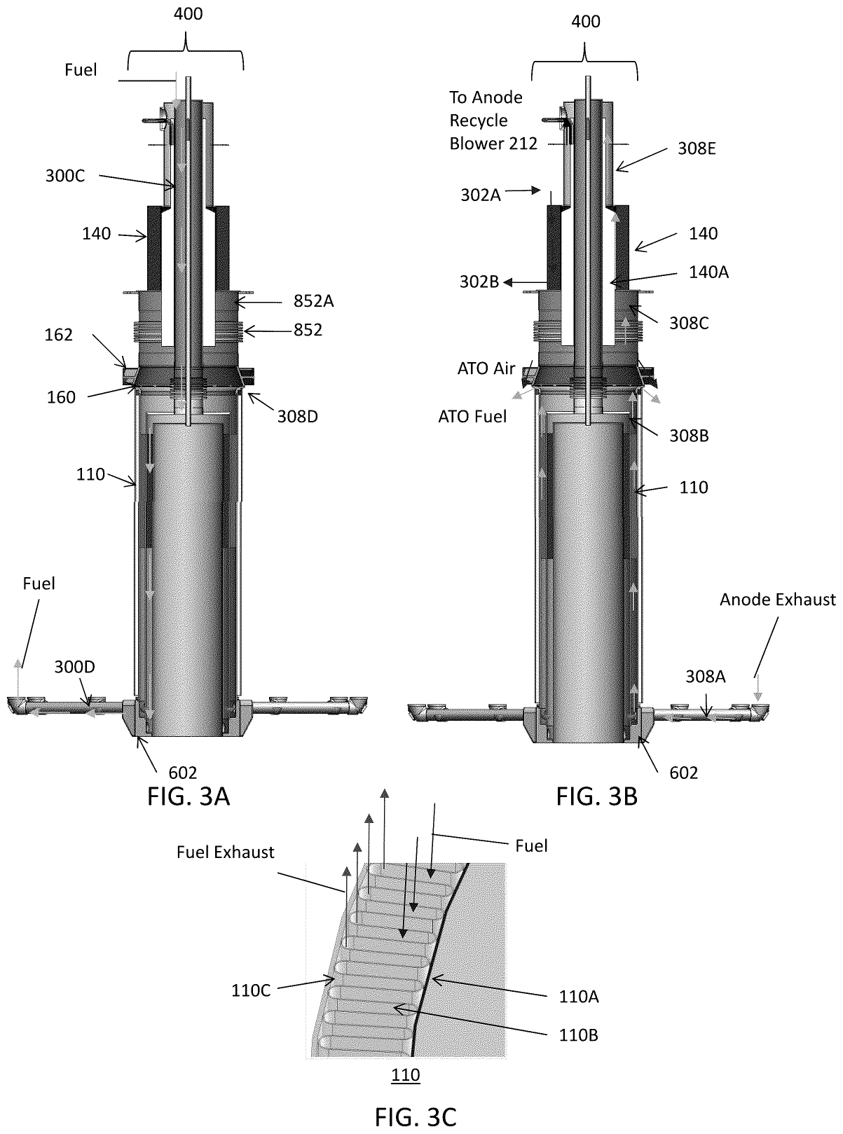

An anode exhaust stream (e.g., the fuel exhaust stream described below with respect to FIGS. 3A-3C) generated in the stacks 102 is provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 160 by anode exhaust conduit 308B. A first portion of the anode exhaust may be provided from the splitter 160 to the anode exhaust cooler 140 through the anode exhaust conduit 308C. A second portion of the anode exhaust may be provided from the splitter 160 to the ATO 150 through the anode exhaust conduit 308D. The first portion of the anode exhaust heats the air inlet stream in the anode exhaust cooler 140 and may then be provided from the anode exhaust cooler 140 to the mixer 210 through the anode exhaust conduit 308E. The anode recycle blower 212 may be configured to move anode exhaust though anode exhaust conduit 308E.

Cathode exhaust generated in the stacks 102 flows to the ATO 150 through cathode exhaust conduit 304A. The vortex generator 162 may be disposed in the exhaust conduit 304A and may be configured to swirl the cathode exhaust. The anode exhaust conduit 308D may be fluidly connected to the vortex generator 162 or to the cathode exhaust conduit 304A or the ATO 150 downstream of the vortex generator 162. The swirled cathode exhaust may mix with the second portion of the anode exhaust provided by the splitter 160 before being provided to the ATO 150. The mixture may be oxidized in the ATO 150 to generate an ATO exhaust. The ATO exhaust flows from the ATO 150 to the cathode recuperator 120 through the cathode exhaust conduit 304B. Exhaust flows from the cathode recuperator and out of the hotbox 100 through cathode exhaust conduit 304C.

An optional water injector (not shown) may be provided on the anode exhaust conduit 308C. The water injector may comprise a nozzle or pipe connected to a water source (e.g., water tank or municipal water supply pipe). The injector injects the water into the anode exhaust stream, where the water is vaporized and converted to steam. Alternatively or in addition, a steam generator (not shown in FIG. 1) may be located in the hot box to provide steam into the mixer 210. The steam generator may comprise one or more water pipes located in the path of the cathode exhaust stream, such that the cathode exhaust stream exiting the cathode recuperator 120 via conduit 304C vaporizes the water in the one or more water pipes.

The system 10 may further contain a system controller 225 configured to control various elements of the system 10. The controller 225 may include a central processing unit configured to execute stored instructions. For example, the controller 225 may be configured to control fuel and/or air flow through the system 10, according to fuel composition data.

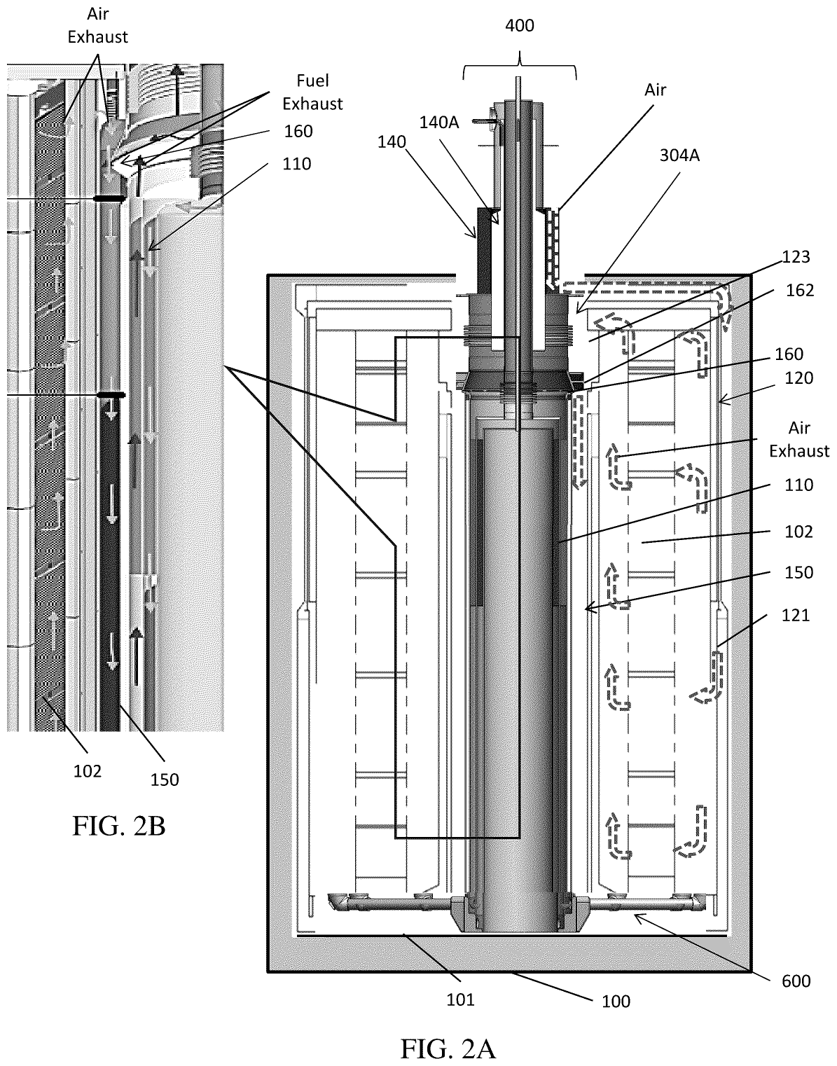

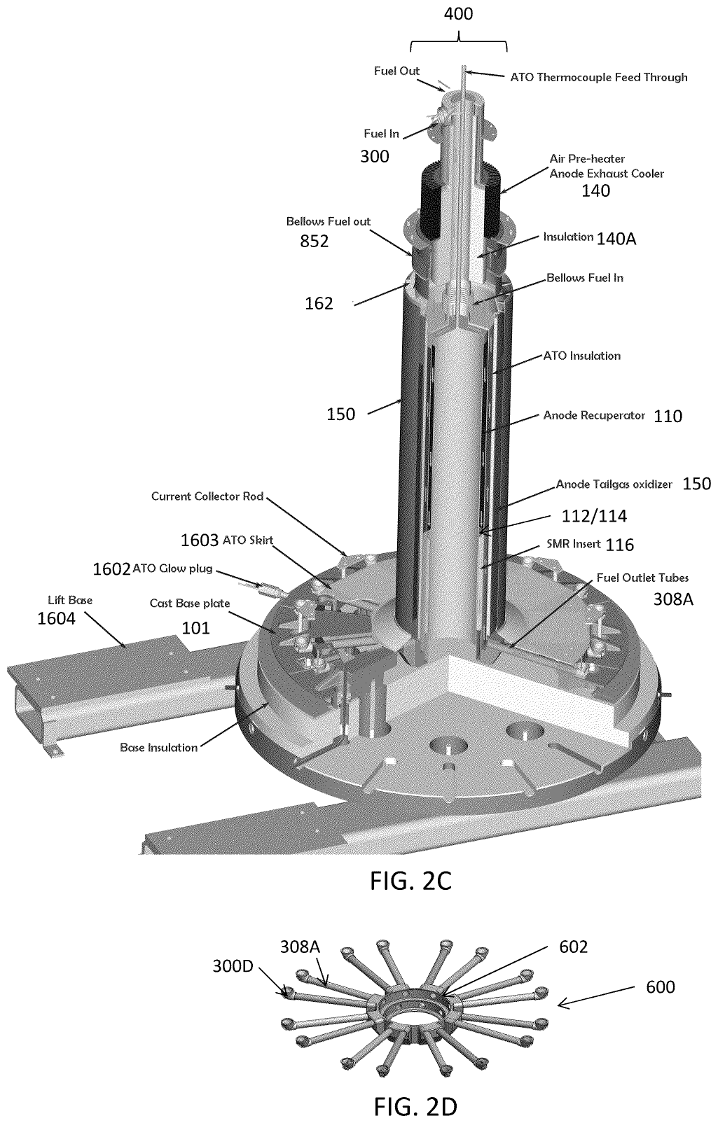

FIG. 2A is a sectional view showing components of the hot box 100 of the system 10 of FIG. 1, and FIG. 2B shows an enlarged portion of FIG. 2A. FIG. 2C is a three-dimensional cut-away view of a central column 400 of the system 10, according to various embodiments of the present disclosure, and FIG. 2D is a perspective view of an anode hub structure 600 disposed in a hot box base 101 on which the column 400 may be disposed.

Referring to FIGS. 2A-2D, the fuel cell stacks 102 may be disposed around the central column 400 in the hot box 100. For example, the stacks 102 may be disposed in a ring configuration around the central column 400 and may be positioned on the hot box base 101. The column 400 may include the anode recuperator 110, the ATO 150, and the anode exhaust cooler 140. In particular, the anode recuperator 110 is disposed radially inward of the ATO 150, and the anode exhaust cooler 140 is mounted over the anode recuperator 110 and the ATO 150. In one embodiment, an oxidation catalyst 112 and/or the hydrogenation catalyst 114 may be located in the anode recuperator 110 (see FIG. 1). A reforming catalyst 116 may also be located at the bottom of the anode recuperator 110 as a steam methane reformation (SMR) insert. The ATO 150 may include an oxidation catalyst.

The anode hub structure 600 may be positioned under the anode recuperator 110 and ATO 150 and over the hot box base 101. The anode hub structure 600 is covered by an ATO skirt 1603. The vortex generator 162 and fuel exhaust splitter 160 are located over the anode recuperator 110 and ATO 150 and below the anode exhaust cooler 140. An ATO glow plug 1602, which initiates the oxidation of the stack fuel exhaust in the ATO during startup, may be located near the bottom of the ATO 150.

The anode hub structure 600 is used to distribute fuel evenly from the central column to fuel cell stacks 102 disposed around the central column 400. The anode flow hub structure 600 includes a grooved cast base 602 and a “spider” hub of fuel inlet conduits 300D and outlet conduits 308A. Each pair of conduits 300D, 308A connects to a fuel cell stack 102. Anode side cylinders (e.g., anode recuperator 110 inner and outer cylinders and ATO 150 outer cylinder) are then welded or brazed into the grooves in the base 602, creating a uniform volume cross section for flow distribution as discussed below.

A lift base 1604 is located under the hot box base 101, as illustrated in FIG. 2C. In an embodiment, the lift base 1604 includes two hollow arms with which the forks of a forklift can be inserted to lift and move the system, such as to remove the system from a cabinet (not shown) for repair or servicing.

As shown by the arrows in FIGS. 2A and 2B, air enters the top of the hot box 100 and flows through the anode exhaust cooler 140 where it is heated by anode exhaust and then flows into the cathode recuperator 120 where it is heated by ATO exhaust (not shown) from the ATO 150. The heated air then flows inside the cathode recuperator 120 through a first vent or opening 121. The air then flows through the stacks 102 and reacts with fuel (i.e., fuel inlet stream) provided from the anode hub structure 600. Air exhaust flows from the stacks 102, through a second vent or opening 123. The air exhaust then passes through vanes of the vortex generator 162 and is swirled before entering the ATO 150.

The splitter 160 may direct the second portion of the fuel exhaust exiting the top of the anode recuperator 100 through openings (e.g., slits) in the splitter into the swirled air exhaust (e.g., in the vortex generator 162 or downstream of the vortex generator in the cathode exhaust conduit 304A or in the ATO 150). At such the fuel and air exhaust may be mixed before entering the ATO 150.

FIGS. 3A and 3B are side cross-sectional views showing flow distribution through the central column 400, and 3C is a partial perspective view taken through the anode recuperator 110. Referring to FIGS. 2A, 2B, 3A, and 3C, the anode recuperator 110 includes an inner cylinder 110A, a corrugated plate 110B, and an outer cylinder 110C. Fuel from fuel conduit 300C enters the top of the central column 400. The fuel then bypasses the anode exhaust cooler 140 by flowing through its hollow core and then flows through the anode recuperator 110, between the outer cylinder 110C and the and the corrugated plate 110B. The fuel then flows through the hub base 602 and conduits 300D of the anode hub structure 600 shown in FIG. 3B, to the stacks 102.

Referring to FIGS. 2A, 2B, 2C, 3A, and 3B, the fuel exhaust flows from the stacks 102 through conduits 308A into the hub base 602, and from the hub base 602 through the anode recuperator 110, between in inner cylinder 110A and the corrugated plate 110B, and through conduit 308B into the splitter 160. A first portion of the fuel exhaust may flow from the splitter 160 to the anode exhaust cooler 140 through conduit 308C, while a second portion may flow from the splitter 160 to the ATO 150 through conduit 308D, as shown in FIG. 1. The relative amounts of anode exhaust provided to the ATO 150 and the anode exhaust cooler 140 is controlled by the anode recycle blower 212. The higher the blower 212 speed, the larger portion of the anode exhaust is provided into conduit 308C and a smaller portion of the anode exhaust is provided to the ATO 150 via conduit 308D, and vice-versa. Anode exhaust cooler inner core insulation 140A may be located between the fuel conduit 300C and bellows 852/supporting cylinder 852A located between the anode exhaust cooler 140 and the vortex generator 162, as shown in FIG. 3A. This insulation minimizes heat transfer and loss from the first portion of the anode exhaust stream in conduit 308C on the way to the anode exhaust cooler 140. Insulation 140A may also be located between conduit 300C and the anode exhaust cooler 140 to avoid heat transfer between the fuel inlet stream in conduit 300C and the streams in the anode exhaust cooler 140. In other embodiments, insulation 140A may be omitted from inside the cylindrical anode exhaust cooler 140.

FIG. 3B also shows air flowing from the air conduit 302A to the anode exhaust cooler 140 (where it is heated by the first portion of the anode exhaust) and then from the anode exhaust cooler 140 through conduit 302B to the cathode recuperator 120. The first portion of the anode exhaust is cooled in the anode exhaust cooler 140 by the air flowing through the anode exhaust cooler 140. The cooled first portion of the anode exhaust is then provided from the anode exhaust cooler 140 to the anode recycle blower 212 shown in FIG. 1.

The anode exhaust provided to the ATO 150 is not cooled in the anode exhaust cooler 140. This allows higher temperature anode exhaust to be provided into the ATO 150 than if the anode exhaust were provided after flowing through the anode exhaust cooler 140. For example, the anode exhaust provided into the ATO 150 from the splitter 160 may have a temperature of above 350° C., such as from about 350 to about 500° C., for example, from about 375 to about 425° C., or from about 390 to about 410° C. Furthermore, since a smaller amount of anode exhaust is provided into the anode exhaust cooler 140 (e.g., not 100% of the anode exhaust is provided into the anode exhaust cooler due to the splitting of the anode exhaust in splitter 160), the heat exchange area of the anode exhaust cooler 140 may be reduced. The anode exhaust provided to the ATO 150 may be oxidized by the stack cathode exhaust (i.e., air) and provided to the cathode recuperator 120 through the cathode exhaust conduit 304B.

### Cold Weather Configurations

Fuel cell systems are typically rated for operation in ambient air temperatures of about −20° C. or greater. Designing fuel cell systems, such as solid oxide fuel cell (SOFC) systems to work in extreme cold weather conditions (e.g., ambient temperatures less than negative 20° C.) is a challenging task both for outdoor rated as well as indoor rated systems, and particularly for systems that use high volumes of air flow. Conventionally, warming incoming air using one or more heaters to a desired temperature range may require a large amount of energy, which decreases the overall efficiency of the system. In some systems, it may not be possible to add localized heaters to certain components, for example motor bearings, and utilizing components designed for extremely low temperatures may be cost and/or size prohibitive.

In view of such problems, various embodiments provide fuel cell systems that utilize heat generated by exothermic fuel cell reactions to heat incoming ambient air to a desired operating temperature. Various embodiments provide improved efficiency for cold weather operation, as compared to conventional systems. These embodiments provide modifications and components to the fuel cell systems for operation in cold conditions, such as cold weather conditions in ambient air temperatures of less than −20° C., such as −21° C. to −40° C.

In cold weather conditions, the ambient air provided to the anode exhaust cooler 140 may excessively cool the anode exhaust stream, which may cause undesirable water condensation in the anode exhaust stream. Specifically, in the embodiments of the present disclosure, the temperature of the anode exhaust stream exiting the anode exhaust cooler 140 is maintained above about 100° C., such as a temperature of above about 105° C. For example, the anode exhaust may be output from the anode exhaust cooler 140 at a temperature ranging from about 110° C. to about 180° C., such as from about 110° C. to about 120° C., when ambient air temperatures are below −20° C. Therefore, water vapor in the anode exhaust is maintained above the water boiling temperature to prevent water condensation in the anode exhaust. Furthermore, the anode exhaust may be maintained below the maximum operating temperature rating of the anode exhaust blower 212 to prevent damage to the anode exhaust blower 212. For example, if the anode exhaust blower is rated for a maximum operating temperature of 200° C., then the temperature of the anode exhaust entering the anode exhaust blower 212 from the anode exhaust cooler 140 may be maintained at 180° C. or less. Therefore, water condensation (and potential water freezing in the pipes at extreme cold temperatures) is avoided without damaging the anode exhaust blower 212.

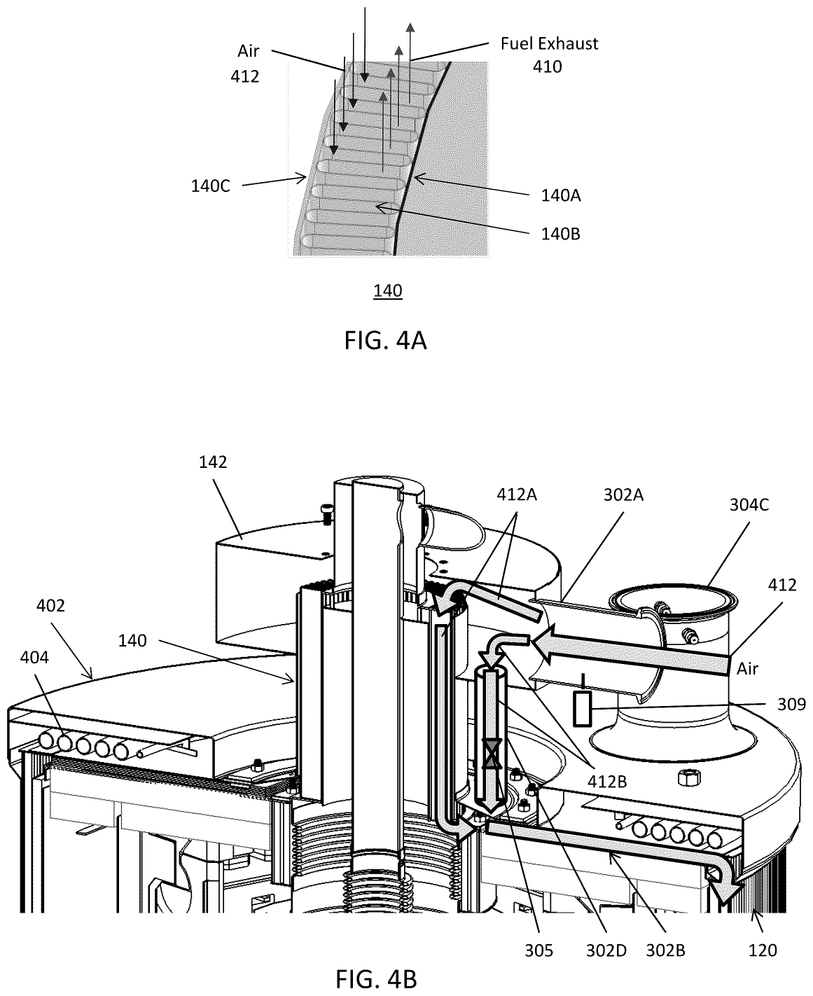

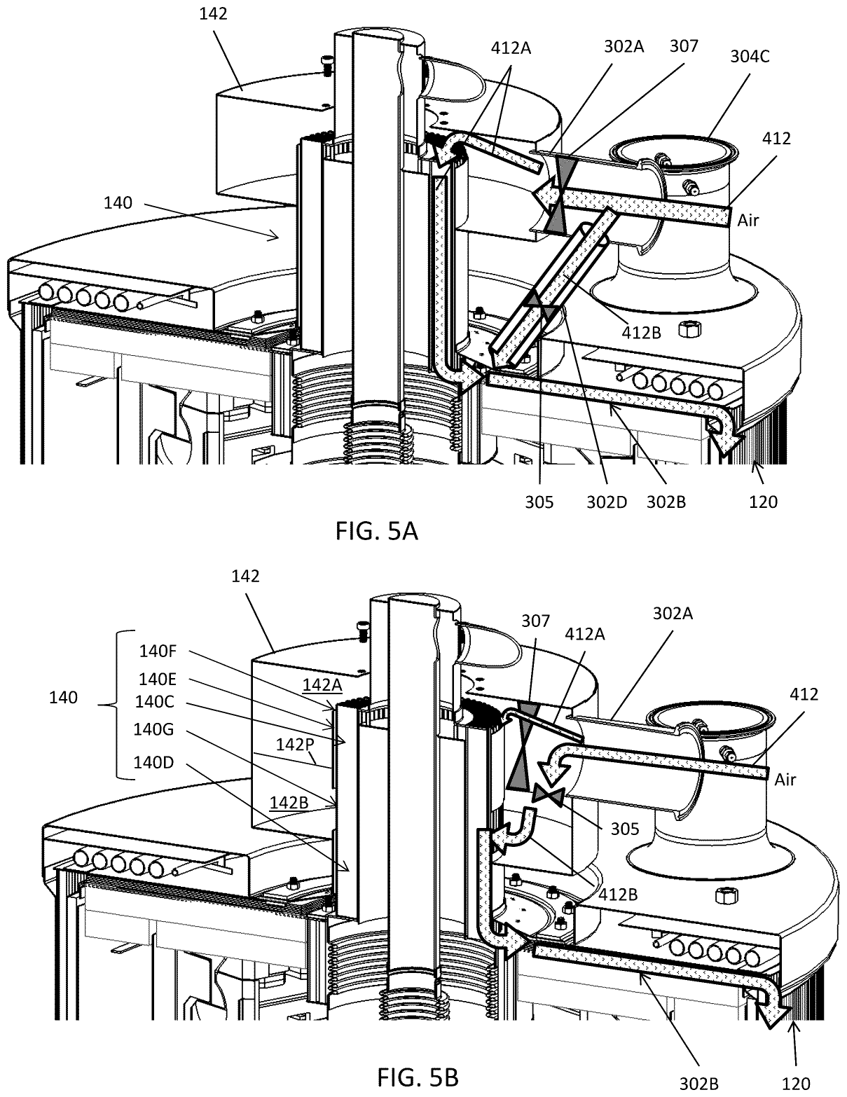

FIG. 4A is a partial perspective view showing fuel exhaust stream 410 and air inlet stream 412 flowing through an anode exhaust cooler 140 of FIG. 1, and FIG. 4B is a partial cross-sectional view of cold weather operation components that may be included in the system 10 of FIG. 1, according to various embodiments of the present disclosure. In the embodiment shown in FIG. 4B, the system 10 may include the optional water evaporator 402 which includes coiled water pipes 404 which are heated by the cathode exhaust stream exiting the cathode recuperator 120. Alternatively, the evaporator 402 may be omitted if a water injector is provided on the anode exhaust conduit 308C.

Referring to FIGS. 1, 4A, and 4B, the anode exhaust cooler 140 may include an inner cylinder 140A, a corrugated plate 140B, and an outer cylinder 140C. Fuel exhaust from fuel exhaust conduit 308C flows into the bottom of the anode exhaust cooler 140 and along a first side of the corrugated plate 140B. The air inlet stream from air conduit 302A enters the top of the anode exhaust cooler 140 and flows along an opposing second side of the corrugated plate 140B. A shroud 142 may be disposed around the anode exhaust cooler 140 and may be configured to provide air received from the air conduit 302A to the anode exhaust cooler 140. For example, the shroud 142 may be a cylinder that surrounds at least a top portion of the anode exhaust cooler 140. A bypass air conduit 302D may fluidly connect the shroud 142 to the air conduit 302B. A bypass valve 305 may be disposed in the bypass air conduit 302D.

Accordingly, a portion 412B of the air inlet stream 412 provided to the shroud 142 may be diverted into the bypass air conduit 302D and may be provided to the air conduit 302B, without passing through the anode exhaust cooler 140. In particular, the air inlet stream 412 flowing into the shroud 142 may be divided into a first air stream 412A that flows into the anode exhaust cooler 140 and exchanges heat with the anode exhaust stream, and a second (i.e., bypass) air stream 412B that flows from the shroud 142 and directly into the air conduit 302B, via the bypass air conduit 302D.

The controller 225 may be configured to control the bypass valve 305 according to the temperature of the air in the air conduit 302A, which may be detected by a temperature sensor 309. For example, the controller 225 may be configured to provide a higher air flow rate (e.g., a higher air mass flow) through the bypass air conduit 302D, in order to prevent excessive cooling of the anode exhaust, due to low ambient air temperatures of the air flowing through the air conduit 302A. In some embodiments, the controller 225 may be configured to control the bypass valve 305, such that the temperature of anode exhaust exiting the anode exhaust cooler 140 remains above about 100° C., such as at a temperature of 110° C. to 180° C., such when ambient air temperatures are below −20° C. As such, the system 10 may be configured to prevent water condensation in the anode exhaust when the system 10 is subjected to extremely cold ambient air, such as ambient air having a temperature of less than −20° C. In other words, if the air inlet stream flowing through the air conduit 302A is determined to be too cold, then the bypass valve 305 is opened (or opened wider than before) to provide at least a part of the air inlet stream (or a greater part of the air inlet stream) directly into the air conduit 302B bypassing the anode exhaust cooler 140. Thus, the anode exhaust stream in the anode exhaust cooler 140 is cooled to a lesser degree than when the bypass valve 305 is closed (i.e., fully or partially closed). In contrast, if the controller 225 determines that the air inlet temperature is relatively high (e.g., at −20° C. or higher, such as a 0 to 25° C., then the bypass valve 305 may be closed or narrowed to provide additional cooling to the anode exhaust stream to maintain it below the rated temperature of the anode exhaust blower 212 to prevent damage to the blower.

In some embodiments, the system 10 may include multiple bypass air conduits 302D connecting the shroud 142 to the air conduit 302B, and additional bypass valves 305 to control air flow through each bypass air conduit 302D. In other embodiments, multiple bypass air conduits 302D may be controlled by a single bypass valve 305. In the case of multiple bypass valves 305, there may be modes of operation where the multiple valves are operated the same way (e.g., all opened or all closed) and modes of operation where the multiple valves are not operated the same way (e.g., some closed and some opened, or multiple valves configured with different degrees of partial openness).

FIGS. 5A and 5B are partial cross-sectional views of modified cold weather operation components that may be included in the system 10 of FIG. 1, according to alternative embodiments of the present disclosure.

Referring to FIG. 5A, the bypass air conduit 302D may fluidly connect the air conduit 302A to the air conduit 302B, thereby bypassing both the anode exhaust cooler 140 and the shroud 142. An additional air control valve 307 may optionally be disposed in the air conduit 302A downstream of the bypass conduit 302D. The air control valve 307 may be configured to control the air inlet stream flow into the shroud 142 and the anode exhaust cooler 140. In some embodiments, the valve 307 may be actuated to force additional air into the bypass air conduit 302D, in order to prevent water condensation from the anode exhaust in the bypass air conduit 302D.

In this embodiment, if the air inlet stream flowing through the air conduit 302A is determined to be too cold, then the bypass valve 305 is opened (or opened wider than before), while the air control valve 307 is fully or partially closed to provide at least a part of the air inlet stream (or a greater part of the air inlet stream or all of the air inlet stream) directly into the air conduit 302B bypassing the anode exhaust cooler 140. Thus, the anode exhaust stream in the anode exhaust cooler 140 is cooled to a lesser degree than when the bypass valve 305 is closed and the air control valve 307 is opened. In contrast, if the controller 225 determines that the air inlet temperature is relatively high (e.g., at −20° C. or higher, such as a 0 to 25° C., then the bypass valve 305 may be fully or partially closed while the air control valve 307 is fully or partially opened wider to provide additional cooling to the anode exhaust stream to maintain it below the rated temperature of the anode exhaust blower 212 to prevent damage to the blower.

In an alternative embodiment illustrated in FIG. 5B, instead of including the bypass conduit 302D, the shroud 142 is split into an upper portion 142A and lower portion 142B by a horizontal shroud plate 142P. The lower portion 142B of the shroud 142 functions as the bypass conduit (i.e., performs a similar function to conduit 302D described above). Specifically, the bypass valve 305 may be located in the shroud plate 142P, while the air control valve may be located in the upper portion 142A of the shroud 142. The anode exhaust cooler 140 may include an upper portion 140C surrounded by the upper portion 142A of the shroud 142 and a lower portion 140D surrounded by the lower portion 142B of the shroud 142. The periphery of the anode exhaust cooler 140 is surrounded by a cylindrical baffle plate 140E. The baffle plate 140E includes an upper air inlet opening 140F located above the shroud plate 140P between the upper portion 140C of the anode exhaust cooler 140 and the upper portion 142A of the shroud 142. The baffle plate 140E also includes lower air inlet opening 140G located below upper air inlet opening 140F and below the shroud plate 142P between the lower portion 140D of the anode exhaust cooler 140 and the lower portion 142B of the shroud 142.

In this embodiment, if the air inlet stream flowing through the air conduit 302A is determined to be too cold, then the bypass valve 305 is opened (or opened wider than before), while the air control valve 307 is fully or partially closed to provide at least a portion 412B of the air inlet stream 412 (or a greater part of the air inlet stream or all of the air inlet stream) into the lower portion 140D of the anode exhaust cooler 140 through the lower air inlet opening 140G and the lower portion 412B of the shroud 412. In this embodiment, at least the portion 412B of the air inlet stream 412 bypasses the upper portion 140C of the anode exhaust cooler 140. Thus, the anode exhaust stream in the anode exhaust cooler 140 is cooled to a lesser degree than when the bypass valve 305 is closed and the air control valve 307 is opened because the anode exhaust stream and at least the second portion 412B of the air inlet stream 412 flow past each other in the anode exhaust cooler 140 along a shorter path for a shorter period of time.

In contrast, if the controller 225 determines that the air inlet temperature is relatively high (e.g., at −20° C. or higher, such as a 0 to 25° C.), then the bypass valve 305 may be fully or partially closed while the air control valve 307 is fully or partially opened wider to provide all or a larger portion 412A of the air inlet stream 412 into the upper portion 140C of the anode exhaust cooler 140 through the upper inlet opening 140F and the upper portion 412A of the shroud 412. Thus, additional cooling is provided to the anode exhaust stream to maintain it below the rated temperature of the anode exhaust blower 212 to prevent damage to the blower, since the anode exhaust stream and at least the first portion 412A of the air inlet stream 412 flow past each other in the anode exhaust cooler 140 along a longer path for a longer period of time.

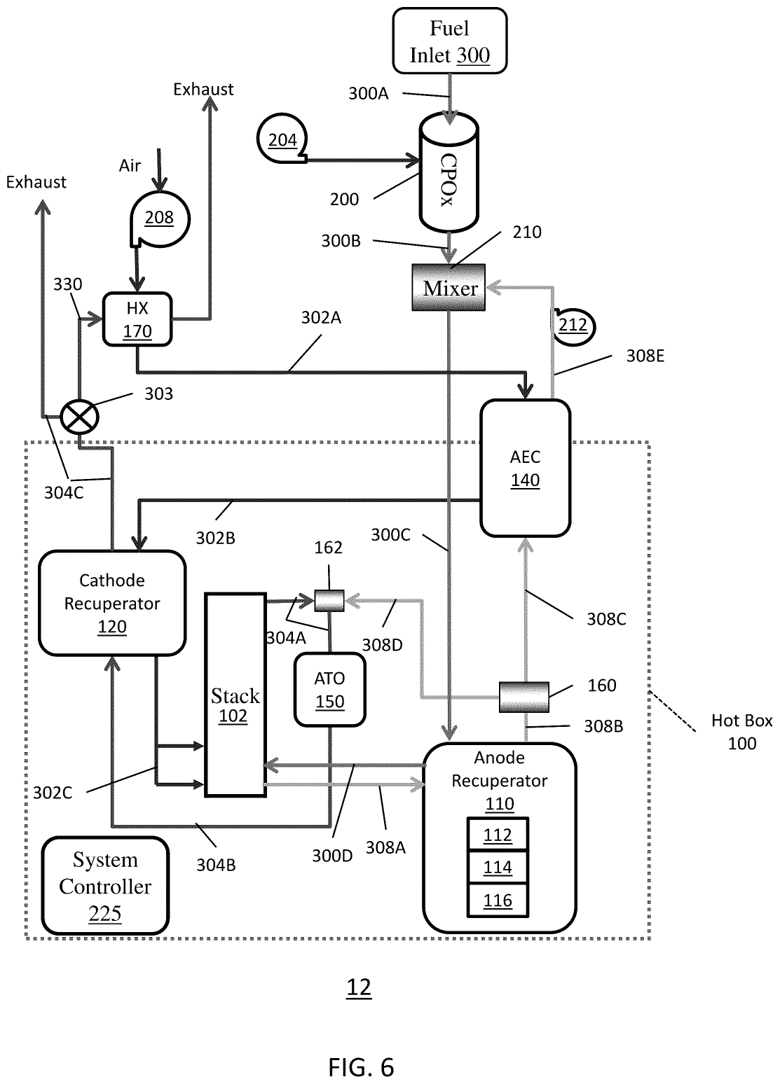

FIG. 6 is a schematic view of a fuel cell system 12, according to another embodiment of the present disclosure. The fuel cell system 12 may be similar to the fuel cell system 10 of FIG. 1. As such, only the differences therebetween will be discussed in detail.

Referring to FIG. 6, the system 12 may include an exhaust heat exchanger 170, an optional exhaust valve 303, and a system exhaust conduit or chimney 330. The exhaust heat exchanger 170 may be configured to preheat air in the air conduit 302A by extracting heat from cathode exhaust output via the cathode exhaust conduit 304C from the hotbox 100. In particular, the exhaust valve 303 may divert all or a portion of the cathode exhaust from the cathode exhaust conduit 304C into the system exhaust conduit 330, which may provide all or a portion of the warm the cathode exhaust to the heat exchanger 170. In some embodiments, the heat exchanger 170 and/or system exhaust conduit 330 may be fluidly connected to multiple hotboxes 100.

The exhaust valve 303 may be a two-way valve or a proportional valve configured to selectively control an amount of cathode exhaust that is provided to the heat exchanger 170. Cathode exhaust remaining in the cathode exhaust conduit 304C may be provided to the system exhaust conduit 330 or may be separately vented from the system 12. In particular, the controller 225 may be configured to control the exhaust valve 303 according to the temperature of the air in the air conduit 302A, or the anode exhaust temperature in the anode exhaust conduit 308E. For example, the controller 225 may be configured to provide a higher cathode exhaust flow rate (e.g., a higher exhaust mass flow) to the heat exchanger 170 by opening or opening wider the exhaust valve 303, in order to heat the air inlet stream in the air conduit 302A to compensate for lower ambient air temperatures. Alternatively, the controller 225 may be configured to fully or partially close the exhaust valve 303, such that no cathode exhaust or less cathode exhaust is diverted from the cathode exhaust conduit 304C to the heat exchanger 170, when ambient air temperatures are high enough that no additional air inlet stream heating is required.

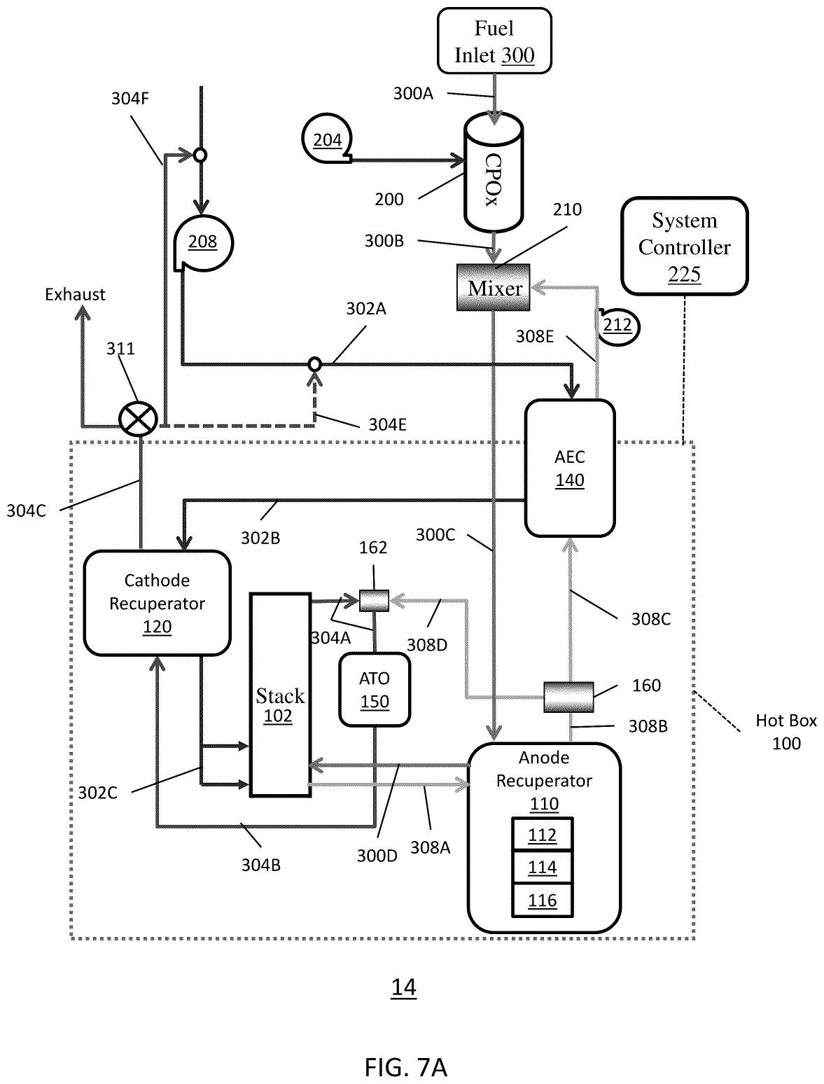

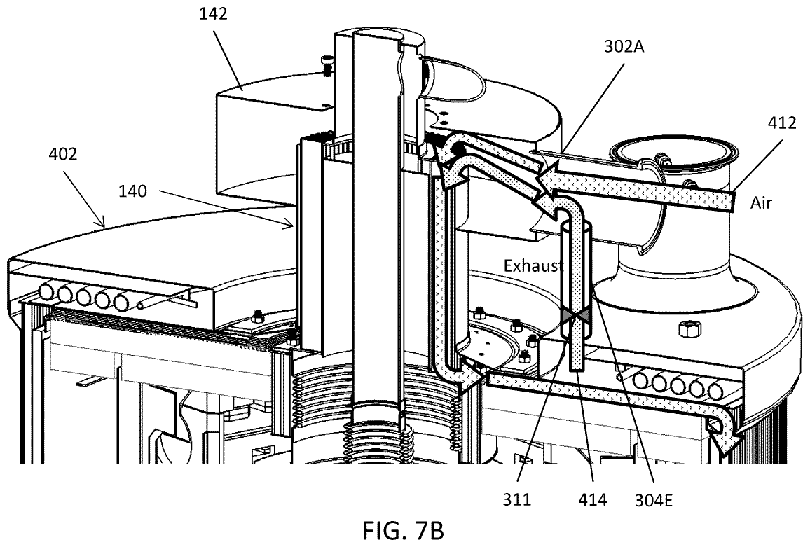

FIG. 7A is a schematic view of a fuel cell system 14, according to various embodiments of the present disclosure, and FIG. 7B is a partial cross-sectional view showing exemplary components of system 14 of FIG. 7A. The fuel cell system 14 may be similar to the fuel cell system 12 of FIG. 6. As such, only the differences therebetween will be discussed in detail.

Referring to FIGS. 7A and 7B, the system 14 may include a cathode exhaust diversion conduit 304E and an exhaust valve 311. The diversion conduit 304E may be configured to provide at least some of the cathode exhaust stream 414 flowing out of the cathode recuperator 120 (e.g., through the cathode exhaust conduit 304C) into the air conduit 302A. As such, the warm cathode exhaust may mix with the incoming cold air inlet stream 412, thereby increasing the temperature of the air provided to the anode exhaust cooler 140. Therefore, excessive cooling of anode exhaust in the anode exhaust cooler 140 may be prevented, which may improve overall system efficiency.

As shown in FIGS. 7A and 7B, the diversion conduit 304F may be fluidly connected to the air conduit 302A upstream of the air blower 208. In an alternative configuration, the diversion conduit 304E may be fluidly connected to the air conduit 302A, downstream of the air blower 208, as shown by the dashed arrow in FIG. 7A. In the alternative configuration, a device, such as an additional blower, may be added to increase the pressure on the diversion conduit 304E. Alternatively, the cold air in the air conduit 302A may pass through a venturi located on the air conduit 302A and suck in the hot cathode exhaust from the diversion conduit 304E.

The exhaust valve 311 may be configured to control exhaust flow through the diversion conduit 304E or 304F. In particular, the controller 225 may be configured to control the exhaust valve 311, based on the temperature of ambient air supplied to the air conduit 302A. For example, the controller 225 may be configured to provide higher exhaust flow rates at lower ambient air temperatures, in order to heat the ambient air to a desired temperature, such as a temperature ranging from about 0° C. to about 20° C., such as a temperature ranging from about 5° C. to about 15° C., or about 10° C.

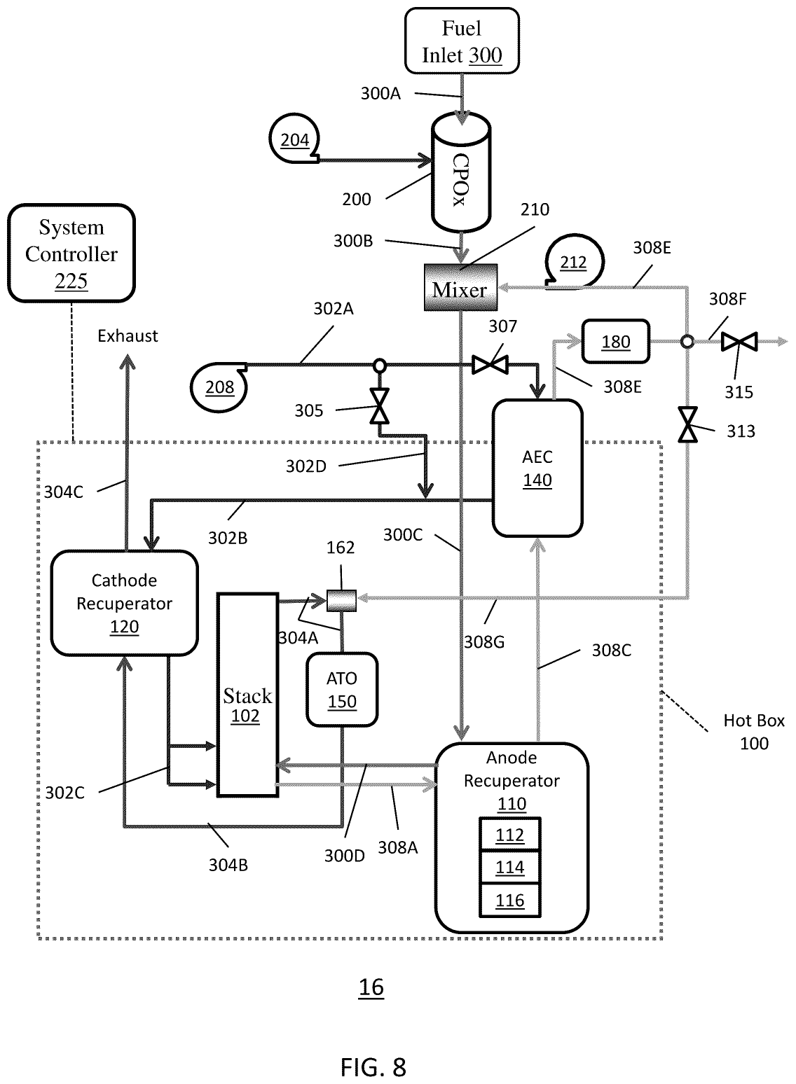

FIG. 8 is a schematic view of a fuel cell system 16, according to various embodiments of the present disclosure. The fuel cell system 16 may be similar to the fuel cell system 10 of FIG. 1. As such, only the differences therebetween will be discussed in detail.

Referring to FIG. 8, the system 16 may include an anode recycle heat exchanger 180, an ATO feed valve 313 located on an anode exhaust conduit 308G, and an anode exhaust export valve 315 located on an anode exhaust export conduit 308F. The anode recuperator 110 may be fluidly connected to the anode exhaust cooler 140 by anode exhaust conduit 308C, and the splitter 160 of FIG. 1 may be omitted. The anode exhaust cooler 140 may be fluidly connected to the anode exhaust heat exchanger 180 and the mixer 210 by the anode exhaust conduit 308E. The anode exhaust conduit 308E may be fluidly connected to the vortex generator 162 by the anode exhaust conduit 308G and may also be fluidly connected to anode exhaust export conduit 308F.

The anode exhaust conduit 308G fluidly connects the anode exhaust conduit 308E to the ATO 150. The ATO feed valve 313 may be configured to control the anode exhaust flow through the anode exhaust conduit 308G from the anode exhaust conduit 308E to the ATO 150. The export valve 315 may control anode exhaust flow through the export conduit 308F. In particular, during system startup, the ATO feed valve 313 may be opened such that at least a portion of the anode exhaust is provided to the ATO 150 via the anode exhaust conduit 308G, and the export valve 315 may be closed. In addition, the air control valve 307 may be closed and the bypass valve 305 may be opened to provide air into the air bypass conduit 302D to bypass the anode exhaust cooler 140, in order to prevent excessive cooling of the anode exhaust during system startup.

During steady-state operation of the system, the ATO feed valve 313 may be closed such that the anode exhaust is provided to the mixer 210 via the anode exhaust conduit 308E, after passing through the anode recycle heat exchanger 180. In particular, the anode recycle heat exchanger 180 may be configured to maintain the anode exhaust to a temperature between 110° C. and 180° C., in order to prevent the condensation of water from the anode exhaust as well as to prevent damage to the anode exhaust recycle blower 212. In some embodiments, the anode recycle heat exchanger 180 may be a passive finned tube heat exchanger configured to receive air flowing through a system cabinet containing the hot box 100 and various system components disposed outside of the hotbox 100. For example, the anode recycle heat exchanger 180 may be positioned near the air intake of the cabinet. In another embodiment, the anode recycle heat exchanger 180 may be an active finned tube heat exchanger located adjacent to a fan which blows cabinet air onto the anode recycle heat exchanger 180. In some embodiments, air conduit 302D may be used to bypass the anode exhaust cooler 140, in order to prevent water condensation in the anode exhaust due to excessive cooling of the anode exhaust in the anode exhaust cooler 140. For example, the anode exhaust cooler 140 may be at least partially bypassed if the system 16 is provided with ambient air having a temperature of about 0° C. or less.

Furthermore, during the steady-state system operation, the export valve 315 may be opened after the ATO feed valve 313 is closed to divert at least a portion of the anode exhaust from the anode exhaust export conduit 308F and out of the system 16. For example, the export conduit 308F may be fluidly connected to an external anode exhaust processor (e.g., a combined heat and power (CHP) generation assembly) or a containment vessel. If the export valve 315 is closed, the ATO feed valve 313 may be opened to divert at least a portion of the anode exhaust to the ATO 150. During the opening and closing of the valves 313, 315, both valves 313, 315 may remain open for one or more seconds in order to prevent deadheading (e.g., anode exhaust flow disruption).

According to various embodiments illustrated in FIGS. 1 and 4B-8, a fuel cell system (10, 12, 14, and 16) includes a stack 102 of fuel cells, an anode exhaust cooler 140 configured to heat an air inlet stream using heat extracted from an anode exhaust stream output from the stack 102, a first air conduit 302A fluidly connected to an air inlet of the anode exhaust cooler 140 and configured to provide an air inlet stream to the anode exhaust cooler 140, a second air conduit 302B connected to an air outlet of the anode exhaust cooler 140 and configured to receive a heated air inlet stream output from the anode exhaust cooler 140 and to provide the heated air inlet stream into the stack 102 (e.g., directly or via the cathode recuperator 120), a first anode exhaust conduit 308C (e.g., alone or in combination with combination with conduits 308A and 308B) fluidly connecting an anode exhaust outlet of the stack 102 to an anode exhaust inlet of the anode exhaust cooler 140, a second anode exhaust conduit 308 fluidly connecting an anode exhaust outlet of the anode exhaust cooler 140 to a fuel inlet of the stack 102 (e.g., directly or via mixer 210 and fuel conduits 300C and 300D), and at least one component configured to maintain a temperature of an anode exhaust stream exiting the anode exhaust cooler 140 into the second anode exhaust conduit 308E at a temperature above 100° C.

In some embodiments, an anode recycle blower 212 is located on the second anode exhaust stream conduit 308E, and the at least one component is configured to maintain the temperature of the anode exhaust stream exiting the anode exhaust cooler 140 into the second anode exhaust conduit 308E at a temperature between 110° C. and 180° C. to prevent water condensation and damage to the blower 212.

In the embodiment of FIGS. 1, 4B and 5A, the at least one component comprises a bypass air conduit 302D fluidly connecting the first air conduit 302A and the second air conduit 302B and bypassing the anode exhaust cooler 140, and a bypass valve 305 configured to control the air inlet stream flow through the bypass air conduit 302D. In the embodiments illustrated in FIGS. 4B and 5A, a shroud 142 surrounds the anode exhaust cooler 140 and fluidly connects the first air conduit 302A to the air inlet of the anode exhaust cooler 140. The bypass air conduit 302D directly connects either the shroud 412 or the first air conduit 302A to the second air conduit 302B in FIGS. 5A and 4B, respectively.

In the embodiment of FIG. 5B, the at least one component comprises the shroud 412 surrounding the anode exhaust cooler 140. The shroud 412 has an upper portion 412A fluidly connecting the first air conduit 302A to the air inlet 140F of the anode exhaust cooler 140 located in an upper portion 140C of the anode exhaust cooler 140, and a lower portion 412B fluidly connecting the first air conduit 302A to a lower air inlet 140G of the anode exhaust cooler 140 located in a lower portion 140D of the anode exhaust cooler 140.

In the embodiment of FIG. 6, the at least one component comprises the heat exchanger 170 fluidly connected to the first air conduit 302A and the cathode exhaust conduit 304C and configured to preheat the air inlet stream in the first air conduit by extracting heat from a cathode exhaust stream output from the stack 102. As noted above, the cathode exhaust conduit 304 is fluidly connected to a cathode exhaust outlet of the stack 102 (e.g., directly or via the cathode recuperator 120).

In the embodiment of FIGS. 7A and 7B, the at least one component comprises a cathode exhaust diversion conduit 304E or 304F fluidly connecting the cathode exhaust conduit 304C to the first air conduit 302A. The cathode exhaust conduit 304 is fluidly connected to a cathode exhaust outlet of the stack 102 (e.g., directly or via the cathode recuperator 120).

In the embodiment of FIG. 8, the at least one component may include the anode recycle heat exchanger 180 and/or the bypass air conduit 302D, which may be used to prevent water from condensing out of the anode exhaust and/or damage to the anode recycle blower 212.

In the embodiments of FIGS. 1 and 4B-8, a method of operating a fuel cell system (10, 12, 14, and 16) includes providing an anode exhaust stream from a stack 102 of fuel cells into an anode exhaust cooler 140, providing an air inlet stream 412 into the anode exhaust cooler 140 and heating the air inlet stream using heat extracted from the anode exhaust stream, providing a heated air inlet stream output from the anode exhaust cooler 140 into the stack 102, providing a cooled anode exhaust stream at a temperature between 110° C. and 180° C. from the anode exhaust cooler 140 into an anode recycle blower 212, and recycling at least a portion of the cooled anode exhaust stream into a fuel inlet stream provided into the stack 102.

In one embodiment, the fuel cell system (10, 12, 14, 16) is operated in an air temperature of less than negative 20° C., such as between negative 21° C. and negative 40° C.

In the embodiments of FIGS. 1, 4B, 5A and 5B, at least a portion of the air inlet stream bypasses the anode exhaust cooler 140 prior to being provided into the stack 102 in order to provide the cooled anode exhaust stream at the temperature between 110° C. and 180° C. from the anode exhaust cooler 140 into the anode recycle blower 102.

In the embodiment of FIG. 4B, the at least the portion of the air inlet stream bypasses the anode exhaust cooler 140 from a shroud 142 surrounding the anode exhaust cooler 140. In the embodiment of FIG. 5A, the at least a portion of the air inlet stream may bypass the anode exhaust cooler 140 from the first air conduit 302A into the second air conduit 302B without entering the shroud 142.

In the embodiment of FIG. 5B, a first portion 412A of the air inlet stream 412 from an upper portion 142A of the shroud 142 surrounding the anode exhaust cooler 140 is provided into an upper portion 140C of the anode exhaust cooler 140. A second portion 412B of the air inlet stream 412 is provided from a lower portion 142B of the shroud 142 into a lower portion 140D of the anode exhaust cooler 140 in order to provide the cooled anode exhaust stream at the temperature between 110° C. and 180° C. from the anode exhaust cooler 140 into the anode recycle blower 212.

In the embodiment of FIGS. 7A and 7B, at least a portion of a cathode exhaust stream from the stack 102 is provided into the air inlet stream 412 in order to provide the cooled anode exhaust stream at the temperature between 110° C. and 180° C. from the anode exhaust cooler 140 into the anode recycle blower 212.

In the embodiment of FIG. 6, at least a portion of the air inlet stream 412 is provided into a heat exchanger 170 upstream of the anode exhaust cooler 140, and at least a portion of a cathode exhaust stream is provided from the stack 102 into the heat exchanger 170 to heat the air inlet stream in order to provide the cooled anode exhaust stream at the temperature between 110° C. and 180° C. from the anode exhaust cooler 140 into the anode recycle blower 212.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a stack of fuel cells;
an anode exhaust cooler configured to heat an air inlet stream using heat extracted from an anode exhaust stream output from the stack;
a first air conduit fluidly connected to an air inlet of the anode exhaust cooler and configured to provide an air inlet stream to the anode exhaust cooler;
a second air conduit connected to an air outlet of the anode exhaust cooler and configured to receive a heated air inlet stream output from the anode exhaust cooler and to provide the heated air inlet stream into the stack;
a first anode exhaust conduit fluidly connecting an anode exhaust outlet of the stack to an anode exhaust inlet of the anode exhaust cooler;
a second anode exhaust conduit fluidly connecting an anode exhaust outlet of the anode exhaust cooler to a fuel inlet of the stack; and
at least one component configured to maintain a temperature of an anode exhaust stream exiting the anode exhaust cooler into the second anode exhaust conduit at a temperature above 100° C.

2. The fuel cell system of claim 1, further comprising an anode recycle blower located on the second anode exhaust conduit, wherein the at least one component is configured to maintain the temperature of the anode exhaust stream exiting the anode exhaust cooler into the second anode exhaust conduit at a temperature between 110° C. and 180° C.

3. The fuel cell system of claim 1, wherein the at least one component comprises:
a bypass air conduit fluidly connecting the first air conduit and the second air conduit and bypassing the anode exhaust cooler; and
a bypass valve configured to control the air inlet stream flow through the bypass air conduit.

4. The fuel cell system of claim 3, further comprising an air control valve configured to control air flow through the first air conduit.

5. The fuel cell system of claim 3, further comprising a shroud surrounding the anode exhaust cooler and fluidly connecting the first air conduit to the air inlet of the anode exhaust cooler, wherein the bypass air conduit directly connects the shroud or the first air conduit to the second air conduit, and wherein the shroud surrounds an upper portion of the anode exhaust cooler and the second air conduit is fluidly connected to a lower portion of the anode exhaust cooler.

6. The fuel cell system of claim 3, further comprising:
an anode recycle heat exchanger located on the second anode exhaust conduit;
an anode tail gas oxidizer;
a third anode exhaust conduit which fluidly connects the second anode exhaust conduit to the anode tail gas oxidizer;
an anode tail gas oxidizer feed valve located on the third anode exhaust conduit;
an anode exhaust export conduit fluidly connected to the second anode exhaust conduit; and
an anode exhaust export valve located on the anode exhaust export conduit,
wherein:
during startup of the fuel cell system, the anode tail gas oxidizer feed valve is configured to be open and the anode exhaust export valve is configured to be closed; and
during steady-state operating of the fuel cell system, the anode tail gas oxidizer feed valve is configured to be closed and the anode exhaust export valve is configured to be open.

7. The fuel cell system of claim 1, wherein the at least one component comprises a shroud surrounding the anode exhaust cooler and having an upper portion fluidly connecting the first air conduit to the air inlet of the anode exhaust cooler located in an upper portion of the anode exhaust cooler, and a lower portion fluidly connecting the first air conduit to a lower air inlet of the anode exhaust cooler located in a lower portion of the anode exhaust cooler.

8. The fuel cell system of claim 7, wherein the shroud comprises a horizontal shroud plate separating the upper portion of the shroud and the lower portion of the shroud.

9. The fuel cell system of claim 8, further comprising a bypass valve configured to control air flow from the upper portion of the shroud, through the horizontal shroud plate, and into the lower portion of the shroud.

10. The fuel cell system of claim 8, wherein the anode exhaust cooler comprises a cylindrical baffle plate comprising an upper air inlet opening exposing the upper portion of the anode exhaust cooler, and a lower air inlet opening exposing the lower portion of the anode exhaust cooler.

11. The fuel cell system of claim 1, wherein the at least one component comprises a cathode exhaust diversion conduit fluidly connecting a cathode exhaust conduit to the first air conduit, and wherein the cathode exhaust conduit is fluidly connected to a cathode exhaust outlet of the stack.

12. The fuel cell system of claim 1, wherein:
the at least one component comprises a heat exchanger fluidly connected to the first air conduit and a cathode exhaust conduit and configured to preheat the air inlet stream in the first air conduit by extracting heat from a cathode exhaust stream output from the stack; and
the cathode exhaust conduit is fluidly connected to a cathode exhaust outlet of the stack.

13. The fuel cell system of claim 1, wherein the fuel cells comprise solid oxide fuel cells.

14. A method of operating a fuel cell system, comprising:
providing an anode exhaust stream from a stack of fuel cells into an anode exhaust cooler;
providing an air inlet stream into the anode exhaust cooler and heating the air inlet stream using heat extracted from the anode exhaust stream;
providing a heated air inlet stream output from the anode exhaust cooler into the stack;
providing a cooled anode exhaust stream at a temperature between 110° C. and 180° C. from the anode exhaust cooler into an anode recycle blower; and
recycling at least a portion of the cooled anode exhaust stream into a fuel inlet stream provided into the stack.

15. The method of claim 14, wherein the fuel cell system comprises a solid oxide fuel cell system.

16. The method of claim 14, wherein at least a portion of the air inlet stream bypasses the anode exhaust cooler prior to being provided into the stack in order to provide the cooled anode exhaust stream at the temperature between 110° C. and 180° C. from the anode exhaust cooler into the anode recycle blower.

17. The method of claim 16, wherein the at least the portion of the air inlet stream bypasses the anode exhaust cooler from a shroud surrounding the anode exhaust cooler.

18. The method of claim 14, further comprising:
providing a first portion of the air inlet stream from an upper portion of a shroud surrounding the anode exhaust cooler into an upper portion of the anode exhaust cooler; and
providing a second portion of the air inlet stream from a lower portion of the shroud surrounding the anode exhaust cooler into a lower portion of the anode exhaust cooler in order to provide the cooled anode exhaust stream at the temperature between 110° C. and 180° C. from the anode exhaust cooler into the anode recycle blower.

19. The method of claim 14, further comprising providing at least a portion of a cathode exhaust stream from the stack into the air inlet stream in order to provide the cooled anode exhaust stream at the temperature between 110° C. and 180° C. from the anode exhaust cooler into the anode recycle blower.

20. The method of claim 14, further comprising:
providing at least a portion of the air inlet stream into a heat exchanger upstream of the anode exhaust cooler; and
providing at least a portion of a cathode exhaust stream from the stack into the heat exchanger to heat the air inlet stream in order to provide the cooled anode exhaust stream at the temperature between 110° C. and 180° C. from the anode exhaust cooler into the anode recycle blower.
